(19) United States
(12) Patent Application Publication
(10) Pub. No.: US 2011/0214346 A1
(43) Pub. Date: Sep. 8, 2011

(54) FERTILIZER DELIVERY SYSTEM AND DEVICE

(76) Inventor: Steven Linton, Scottsdale, AZ (US)

(21) Appl. No.: 12/719,453

(22) Filed: Mar. 8, 2010

(51) Int. Cl. A01G 1/00

(52) U.S. Cl. 47/48.5

(57) ABSTRACT

A fertilizer delivery device which includes a fertilizer chamber having an open top and an enclosed bottom having a plurality of openings, and a hollow compartment (having an open top and an opened bottom end) that is contained within, and completely surrounded by, the fertilizer chamber. A fertilizer delivery kit is also disclosed which includes the fertilizer delivery device and one or more containers that fit into the hollow compartment of the fertilizer delivery device. In addition, a method of for enhancing and accelerating the production of produce on produce bearing plants is disclosed.

### FIELD OF THE INVENTION

The present invention relates to a fertilizer delivery device and a kit which includes the same. In addition, the present invention is also directed to a system and method for fertilizing plants and other vegetation, and in particular vegetable and fruit bearing plants, which enable plants (and the vegetables and/or fruit they bear) to grow larger in size at an accelerated pace. The fertilizer delivery device of the present invention includes a fertilizer chamber having an open top and an enclosed bottom and having a plurality of openings, and a hollow compartment (having an open top and an opened bottom end) that is contained within, and completely surrounded by, the fertilizer chamber.

### BACKGROUND OF THE INVENTION

Many types of apparatus have been used to facilitate the growth of plants and to control the fertilization of plants to facilitate that growth. Unfortunately, over fertilization and under fertilization of plants continue to occur despite the numerous devices and apparatuses available in the market.

Over fertilization or under fertilization of plants, such as vegetable and/or fruit bearing plants, is of particular concern in that the over fertilization or under fertilization will ultimately result in the inability of the plant to produce quality vegetables and/or fruits in sufficient quantities. Accordingly, there is a need for a fertilizer delivery device and system which enables the appropriate amount of fertilization to occur in order to facilitate the plants increased growth at an accelerated pace in order to produce sufficient numbers of quality vegetables and/or fruits. In addition, there is also a need for a fertilizer delivery device for vegetable and fruit producing plants that can be reused from season to season. There is also a need for a reusable fertilizer delivery device that can be used with biodegradable or recyclable materials, if necessary, in order to avoid or reduce any environmental imprint left after using the device.

### SUMMARY OF THE INVENTION

In accordance with various aspects of the present invention, a fertilizer delivery device is provided along with a fertilizer delivery device kit which enhances and accelerates the growth of plants bearing produce. In addition, the present invention is also directed to a fertilizer delivery device system and process which also functions to enhance and accelerate the growth of produce bearing plants.

In one exemplary embodiment, the fertilizer delivery device of the present invention includes a fertilizer chamber having an open top end and a closed bottom end where the bottom end has a plurality of openings contained therethrough, and a hollow compartment having an open top end and an open bottom end where the hollow compartment is contained within, and completely surrounded by, the fertilizer chamber. In one aspect of the invention, the fertilizer chamber and the hollow compartment may be comprised of one continuous piece. In addition, the fertilizer delivery device may further include a lid member which fits over the top end of the fertilizer chamber.

In one exemplary embodiment of the lid member, the lid member may include two pieces that are hingedly connected to one another. The two pieces may be identical in size and shape.

Any similar exemplary embodiment, the fertilizer delivery device of the present invention may include an outer hollow body member having an inner perimeter, an outer perimeter, a top end, and a bottom end; an inner hollow body member having an inner perimeter, an outer perimeter, a top end, and a bottom end wherein the inner hollow body member is positioned within the outer hollow body member; and a floor member having a plurality of small openings contained therethrough where the floor member is positioned between, and connected to, the inner perimeter of the bottom end of the outer hollow body member and the outer perimeter of the bottom end of the inner hollow body member thereby creating a fertilizer chamber contained between the inner perimeter of the outer hollow body member and the outer perimeter of the inner hollow body member. Like the above described exemplary embodiments, the outer hollow body member, the inner hollow body member, and the floor member may all be comprised of one continuous piece. In still another exemplary embodiment, the outer hollow body member may be cylindrical in shape. In still another exemplary embodiment, the inner hollow body member may be rectangular in shape or cylindrical in shape. However, it will be understood by those skilled in the art that both the outer hollow body member and the inner hollow body member may comprise any number of shapes and may be provided in any number of sizes. In addition, these embodiments may also further include a lid member which fits over the open top end of the fertilizer chamber.

In one exemplary embodiment, the lid member may include first and second pieces that are connected to one another by hinge mechanism. In one aspect, the hinge mechanism may include two hinge pieces where each hinge piece is connected to the first lid piece, the second lid piece, the outer perimeter of the inner hollow body member near the top end of the inner hollow body member, and the inner perimeter of the outer hollow body member near the top end of the outer hollow body member. The first and second pieces of the lid member may be equal to one another in size and shape and a knob member may be included on one or both of the first and second pieces of the lid.

The present invention is also directed to a fertilizer delivery kit which includes a fertilizer delivery device having a fertilizer chamber completely surrounding a hollow compartment having an open top end and an open bottom end and at least one container capable of fitting within the hollow compartment wherein the container has an open top end and a closed bottom end. In one aspect, the bottom end of the container includes perforations for easily removing all or a portion of the bottom end of the container. The container may be biodegradable and the kit may, in one exemplary embodiment, contain a plurality of containers. In another exemplary embodiment, the fertilizer delivery kit may further include a package of dried manure. In yet another exemplary embodiment, the fertilizer delivery kit may further include a package of fish emulsion.

The present invention also includes a method for enhancing and accelerating the growth of produce on produce bearing plants. One exemplary embodiment of the method includes a) providing a container and fertilizer delivery device having an opening for the container, b) placing a plant in the container on top of the soil and filling the container with soil, c) allowing the plant to grow in the container, d) providing a bed of soil and digging a hole in the soil bed big enough to hold the fertilizer delivery device, e) filling the hole with a mixture of water and fish emulsion, f) allowing the water and fish emulsion to soak into the soil, repeating steps e and f two more times, g) placing a layer of dried grass clippings in the bottom of the hole, h) placing a layer of dried cow manure on top of the grass clippings, i) placing a mixture of bone meal and superphosphate and/or rock phosphate on top of cow manure and dampening it with water, j) placing a layer of soil on top of the bone meal mixture without filling the hole, k) placing the fertilizer delivery device on the top layer of soil in the bottom of the hole, l) removing the bottom from the bottom of the container containing the plant and placing the container in the opening in the fertilizer delivery device, m) filling the open area around the fertilizer delivery device with soil without covering the device or the container, n) filling the area in the device around the opening in the device containing the container with dried cow manure, o) placing a mixture of water and fish emulsion on top of the cow manure contained within the device, p) filling in the area in the device around the opening in the device containing the container with water once a week, and q) staking and/or caging the plant (optional).

Further aspects of the invention and areas of applicability will become apparent from the description provided herein. It should be understood that the description and specific examples are intended for purposes of illustration only and are not intended to limit the scope of the present invention.

### BRIEF DESCRIPTION OF THE DRAWINGS

The drawings described herein are for illustration purposes only and are not intended to limit the scope of the present disclosure in any way. The present invention will become more fully understood from the detailed description and the accompanying drawings wherein:

FIG. 1 is a perspective view of a first exemplary embodiment of the fertilizer delivery device of the present invention shown with the lid partially open;

FIG. 2 is a perspective view of the first exemplary embodiment of the fertilizer delivery device of the present invention shown with the lid removed;

FIG. 3 is a perspective view of the hollow compartment contained within the fertilizer chamber of the fertilizer delivery device shown in FIG. 1;

FIG. 4 is a perspective view of one exemplary embodiment of a lid member for the fertilizer chamber of the first exemplary embodiment of the fertilizer delivery device shown in FIG. 1;

FIG. 5 is a top plan view of the first exemplary embodiment of the fertilizer delivery device shown in FIG. 2;

FIG. 6 is a perspective view of the fertilizer delivery device of FIG. 1 shown in an upside down position;

FIG. 7 is a perspective view of an exemplary embodiment of the fertilizer delivery kit of the present invention which includes a fertilizer delivery device shown with a closed lid having knobs/handles and a container for insertion into the fertilizer delivery device;

FIG. 8 is a perspective view of a second exemplary embodiment of the fertilizer delivery device of the present invention;

FIG. 9 is a perspective view of the second exemplary embodiment of the fertilizer delivery device of the present invention with the lid shown removed;

FIG. 10 is a side elevational view of the second exemplary embodiment of the fertilizer delivery device of the present invention with the lid shown removed;

FIG. 11 is another side elevational view of the second exemplary embodiment of the fertilizer delivery device of the present invention with the lid shown removed;

FIG. 12 is a cross sectional view of the second exemplary embodiment of the fertilizer delivery device of the present invention taken along lines 12-12 of FIG. 10;

FIG. 13 is a cross sectional view of the second exemplary embodiment of the fertilizer delivery device of the present invention taken along lines 13-13 of FIG. 10;

FIG. 14 is a cross sectional view of the second exemplary embodiment of the fertilizer delivery device of the present invention taken along lines 14-14 of FIG. 10;

FIG. 15 is a flow chart showing one exemplary embodiment of the method of the present invention for enhancing and accelerating the growth of produce on produce bearing plants;

FIG. 16 is a perspective view of an exemplary embodiment of the fertilizer delivery device of the present invention shown with a container inserted into the fertilizer delivery device; and

FIG. 17 is a perspective view of the exemplary embodiment of the fertilizer delivery device shown in FIG. 16 with a portion of the lid shown open for accessing the interior of the fertilizer chamber of the fertilizer delivery device.

### DETAILED DESCRIPTION

The following description is merely exemplary in nature and is not intended to limit the present invention or its teachings, applications, or uses thereof. It should be understood that throughout the drawings, corresponding reference numerals indicate like or corresponding parts and features. The description of specific examples indicated in various embodiments and aspects of the present invention are intended for purposes of illustration only and are not intended to limit the scope of the invention disclosed herein. Moreoever, recitation of multiple embodiments having stated features is not intended to exclude other embodiments having additional features or other embodiments incorporating different combinations of the stated features.

The present invention may be described herein in terms of various functional components and processing steps. It should be appreciated that such components and steps may be realized by any number of components configured to perform the specified functions. For example, the present invention may employ a fertilizer delivery device having a hollow compartment contained within a fertilizer chamber wherein the hollow compartment and the fertilizer chamber may each take the shape or form of any number of configurations.

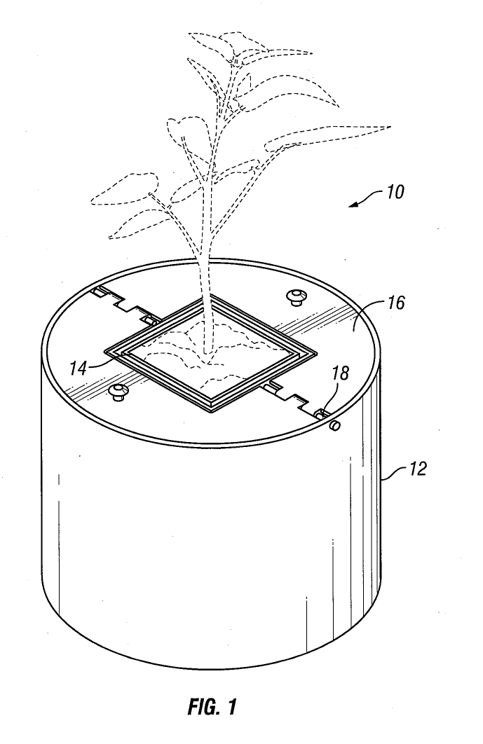

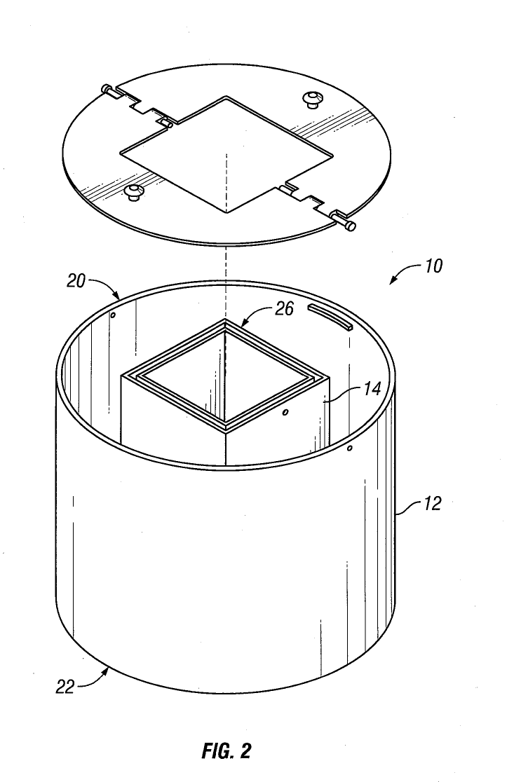

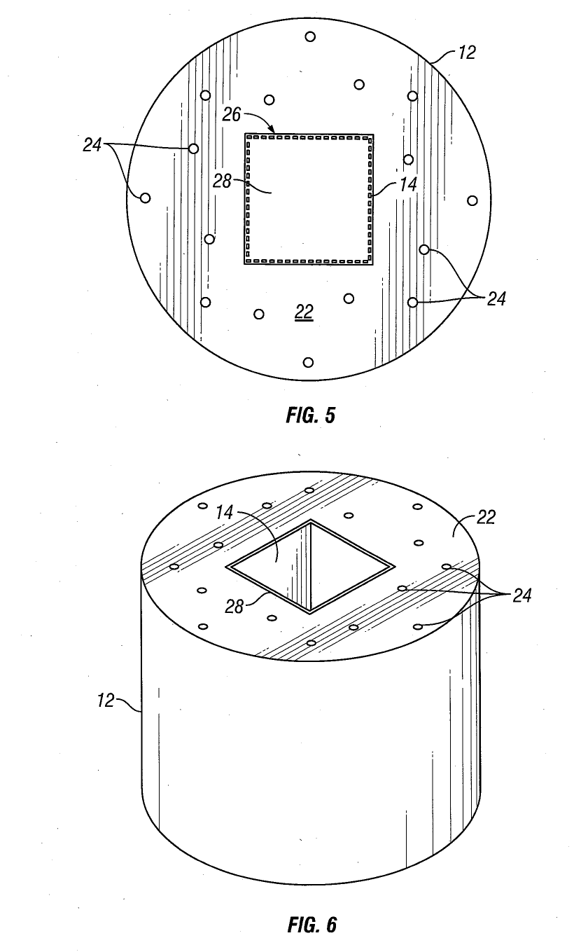

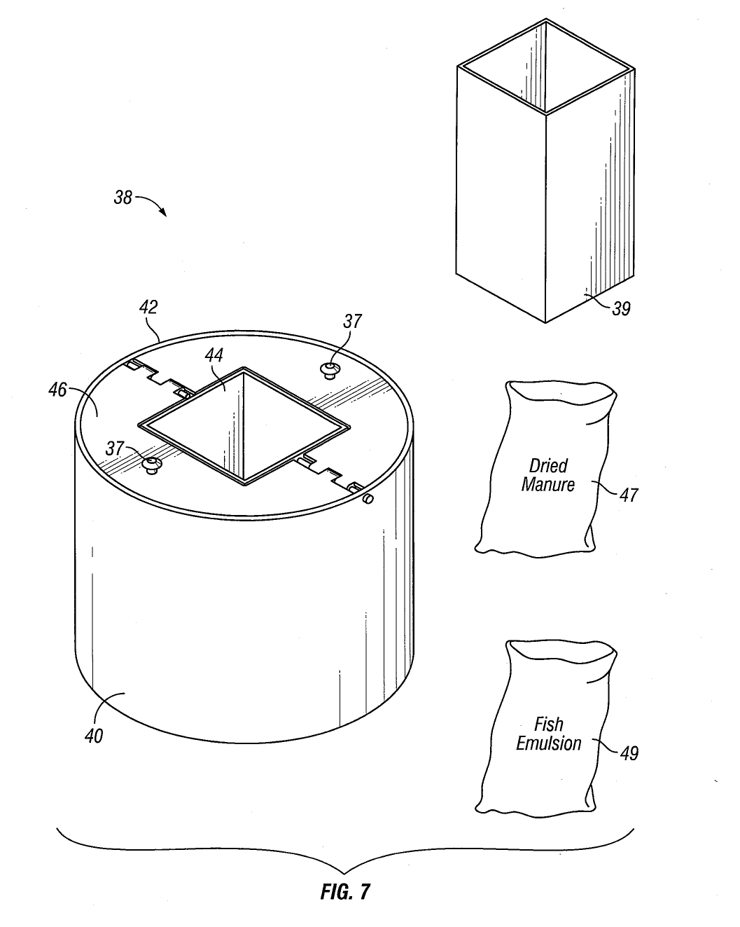

FIG. 1 is a perspective view of a first exemplary embodiment of the fertilizer delivery device 10 of the present invention shown with its lid partially opened. Fertilizer delivery device 10 includes a fertilizer chamber 12 and a hollow compartment 14 contained within, and completely surrounded by, the fertilizer chamber 12. The fertilizer delivery device 10 may also include a lid member 16 which covers the fertilizer chamber 12. The lid member 16 may be connected to the fertilizer chamber 12 by one or more hinges 18. A perspective view of the first exemplary embodiment of the fertilizer delivery device 10 of the present invention shown with the lid member 16 removed is depicted in FIG. 2. As shown in FIG. 2, fertilizer chamber 12 has an open top end 20 and a closed bottom end 22. The closed bottom end 22 has a plurality of openings 24 contained therethrough (see FIGS. 5 and 6). Hollow compartment 14 of fertilizer delivery device 10 includes an open top end 26 and an open bottom end 28 (see FIGS. 5 and 6).

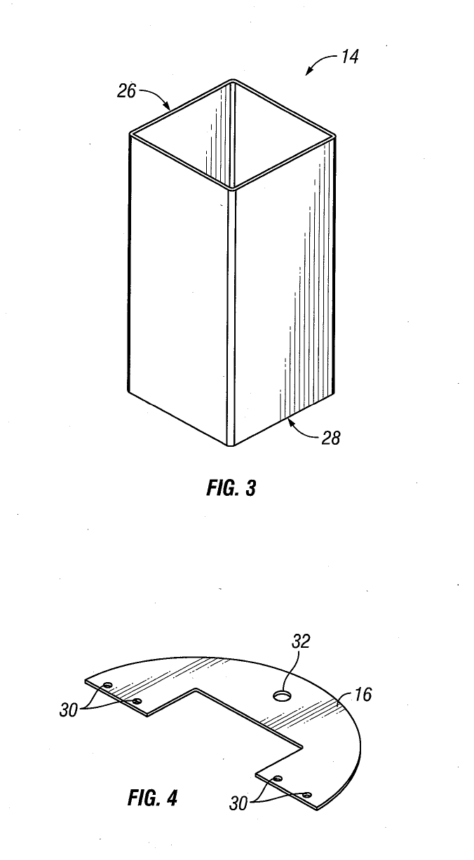

FIG. 3 is a perspective view of the hollow compartment 14 contained within the fertilizer chamber 12 of the fertilizer delivery device 10 shown in FIG. 1. Hollow compartment 14 may be comprised of any number of shapes, sizes, and/or configurations as long as it is contained within, and completely surrounded by, fertilizer chamber 12. In addition, fertilizer chamber 12 and hollow compartment 14 may be comprised of one continuous piece or, alternatively, may be comprised of separate pieces that are connected to one another by any means known in the art. FIG. 3 shows the hollow compartment 14 having the configuration of a hollow rectangular member. A perspective view of one exemplary embodiment of lid member 16 for fertilizer chamber 12 of the first exemplary embodiment of fertilizer delivery device 10 is shown in FIG. 4. Lid member 16 may comprise any number of shapes, sizes, and/or configurations as long as it is capable of covering fertilizer chamber 12 of fertilizer delivery device 10. Lid member 16 shown in FIG. 4 includes openings 30 which can be used for connecting a hinge mechanism to the lid so that the lid is capable of being hingedly connected to the fertilizer chamber 12 and hollow compartment 14 of fertilizer delivery device 10. Lid member 16 may also include one or more openings 32 for attaching a knob member of handle for opening lid member 16.

A top plan view of the first exemplary embodiment of the fertilizer delivery device 10 shown in FIG. 2 is depicted in FIG. 5. Fertilizer chamber 12 has an open top end and a closed bottom end 22 having a plurality of openings 24 contained therethrough. Hollow compartment 14 has an open top end 26 and open bottom end 28 and hollow compartment 14 is contained within, and completely surrounded by, the fertilizer chamber 12. FIG. 6 is a perspective view of the fertilizer delivery device 12 of FIG. 1 shown in an upside down position. As can be seen in FIG. 6, fertilizer chamber 12 has a closed bottom end 22 having a plurality of openings 24 contained therethrough and hollow compartment 14 has an open bottom end 28. Hollow compartment 14 is completely contained within, and completely surrounded by, fertilizer chamber 12.

FIG. 7 is a perspective view of an exemplary embodiment of the fertilizer delivery kit 38 of the present invention which includes a fertilizer delivery device 40 shown with a closed lid 46 having knobs or handles 37 and a container 39 for insertion into the fertilizer delivery device 40. Fertilizer delivery device 40 has a fertilizer chamber 42 completely surrounding a hollow compartment 44 having an open top end and an open bottom end. Further, fertilizer chamber 42 includes a bottom having a plurality of openings therethrough as shown in FIG. 6. The container 39 of fertilizer delivery kit 38 may comprise any number of shapes, sizes, and/or configurations as long as it fits within hollow compartment 44. In addition, container 39 preferably has an open top end and a closed bottom end that can be removed once a plant contained within container 39 is ready to be placed within fertilizer delivery device 40. Fertilizer delivery kit 38 may include one or more containers 39. Containers 39 may be biodegradable. The bottom of container 39 may include perforations for easily removing all or a portion of the bottom of container 39. Fertilizer delivery device 12 may further include a lid member 46 which covers the open top end of fertilizer chamber 42. In addition, fertilizer delivery kit 38 may include a package of dried manure 47 and/or a package of fish emulsion 49.

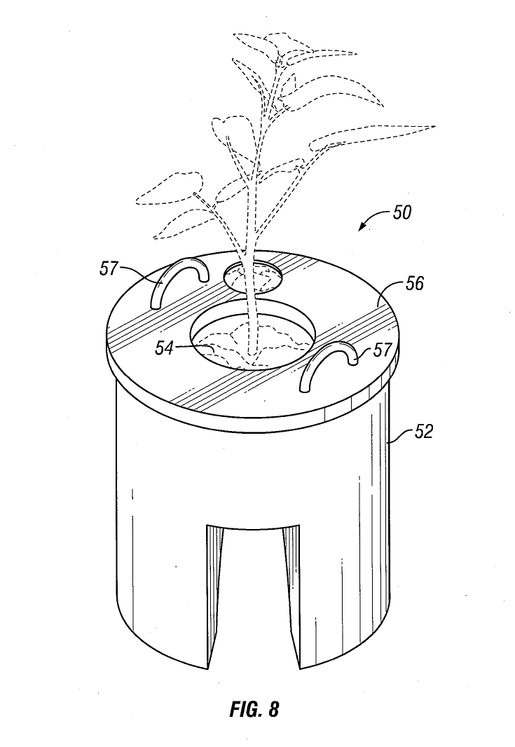

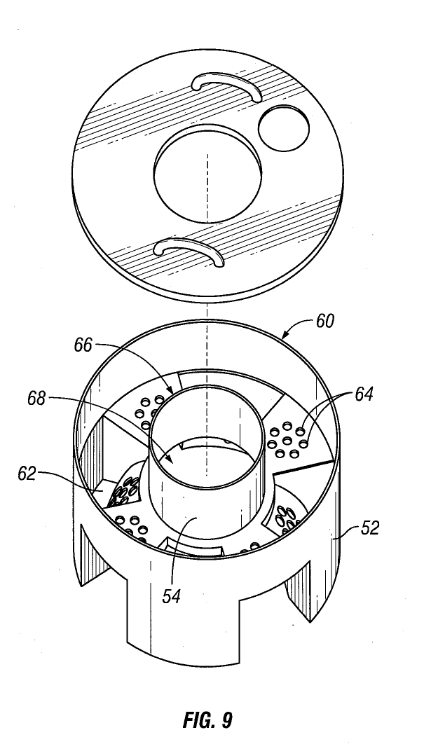

FIG. 8 shows a perspective view of a second exemplary embodiment of a fertilizer delivery device 50 of the present invention. Fertilizer delivery device 50 includes a fertilizer chamber 52 and hollow compartment 54 that is contained within, and completely surrounded by, fertilizer chamber 52. Fertilizer delivery device 50 also includes a lid member 56 which covers the fertilizer chamber 52. Lid 56 may further include handles 57 for removing lid 56 from the top of fertilizer chamber 52. FIG. 9 is a perspective view of the exemplary embodiment of the fertilizer delivery device 50 shown in FIG. 8 with the lid removed. As can be seen in FIG. 9, fertilizer chamber 52 has an open top end 60 and a closed bottom end 62 with a plurality of openings 64 contained therethough. Hollow compartment 54 has an open top end 66 and an open bottom end 68.

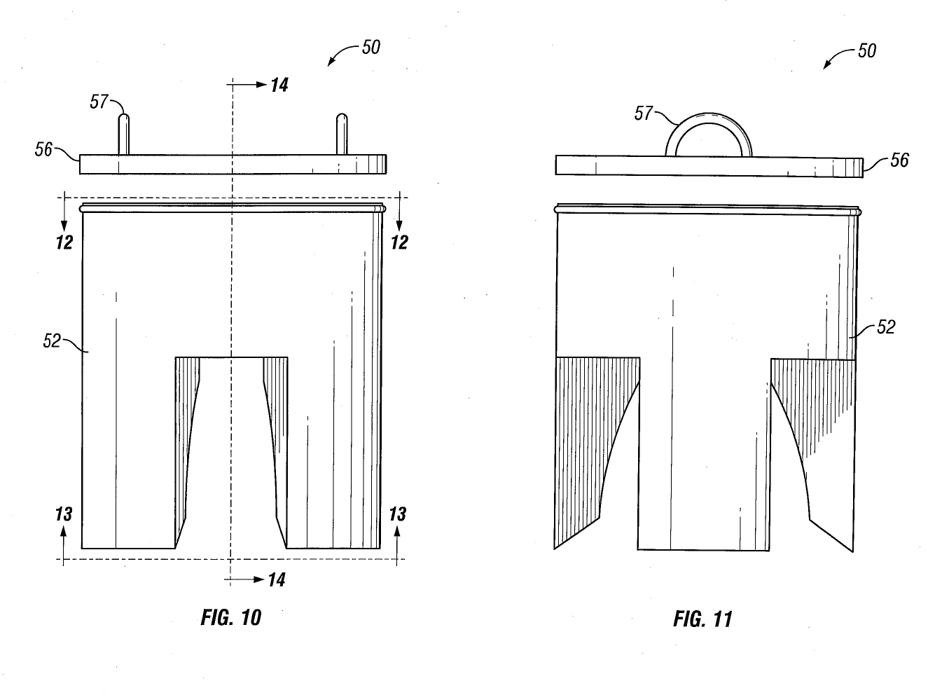

FIG. 10 is a side elevational view of the second exemplary embodiment of the fertilizer delivery device 50 shown with the lid removed. FIG. 11 is another side elevational view of the second exemplary embodiment of the fertilizer delivery device 50 of the present invention shown with the lid removed. As shown in FIGS. 8-11, fertilizer chamber 52 has a configuration which includes a hollow cylinder near the top of the fertilizer chamber 52 and lowered and raised portions within the bottom of fertilizer chamber 52. Further, as shown in FIG. 9, hollow compartment 54 has a configuration of a hollow cylinder with open ends. However, it will be understood by those skilled in the art that fertilizer chamber 52 and hollow compartment 54 may comprise any number of shapes, sizes, and/or configurations as long as hollow compartment 54 is contained within, and completely surrounded by, fertilizer chamber 52.

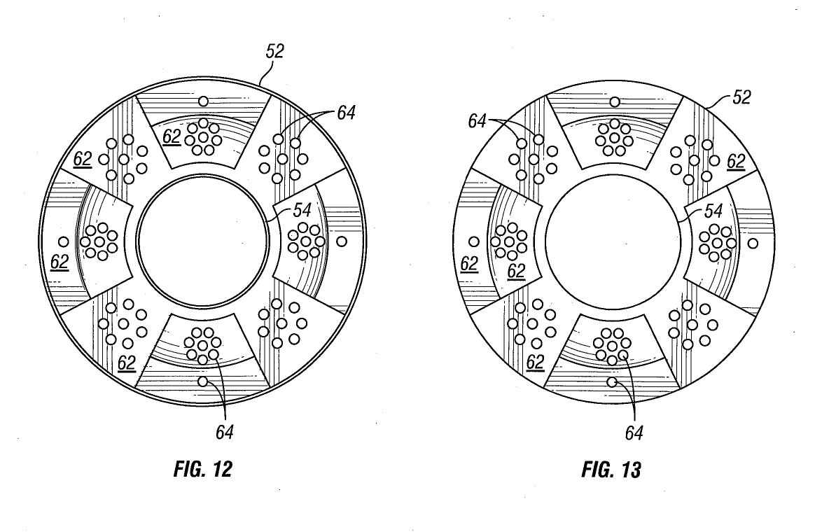

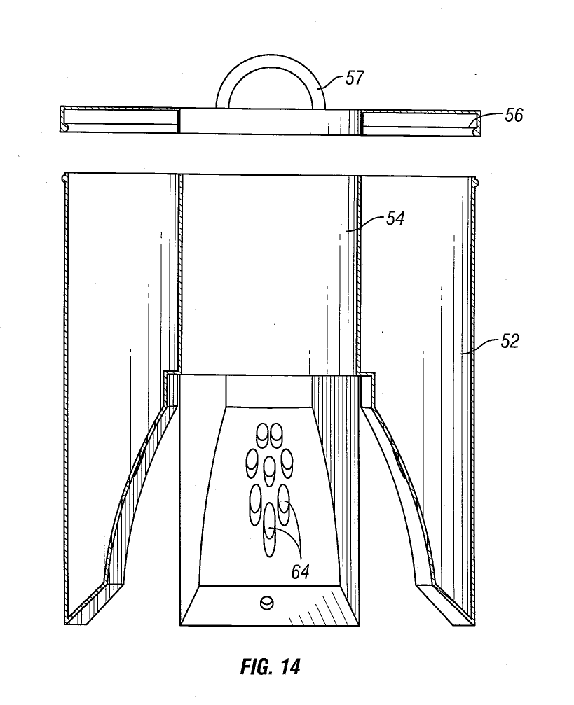

FIG. 12 is a cross-sectional view of the second exemplary embodiment of the fertilizer delivery device 50 of the present invention taken along lines 12-12 of FIG. 10. FIG. 13 is a cross-sectional view of the second exemplary embodiment of the fertilizer delivery device 50 of the present invention taken along lines 13-13 of FIG. 10. Both FIGS. 12 and 13 show that hollow compartment 54 has open top and bottom ends and that fertilizer chamber 52 has an open top end and a closed bottom end 62 having a plurality of openings 64 contained therethrough. FIG. 14 is a cross-sectional view of the second exemplary embodiment of the fertilizer delivery device 50 of the present invention taken along lines 14-14 of FIG. 10. As previously described above, hollow compartment 54 has open top and bottom ends and fertilizer chamber 52 has an open top end 62 and a plurality of openings 64 contained therethrough.

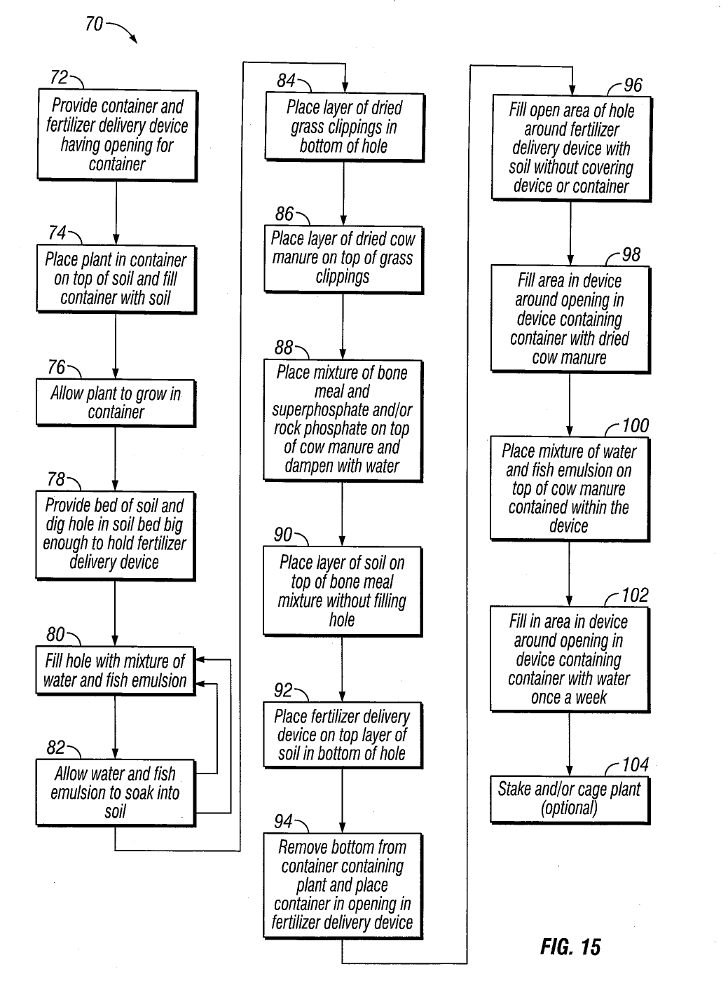

Turning now to FIG. 15, a flowchart is shown of one exemplary embodiment of the method 70 of the present invention for enhancing and accelerating the growth of produce on produce bearing plants. Method 70 includes several steps for insuring that produce bearing plants bear more fruit at an accelerated rate. First, a container and fertilizer delivery device having an opening for the container are provided in step 72. Next, in step 74, a plant is placed in the container on top of a bottom layer of soil contained in the container and the container is then filled with soil so that the space between the plant and container is filled. The plant is then allowed to grow in the container in step 76 and a hole is dug in a soil bed such that it is big enough to hold the fertilizer delivery device in step 78. Next, in step 80, the hole in the soil bed is filled with a mixture of water and fish emulsion and the water and fish emulsion is allowed to soak into the soil in step 82. Steps 80 and 82 are then repeated one or two more times, preferably two more times.

Next, in step 84, a layer of dried grass clippings is placed in the bottom of the hole followed by placing a layer of dried cow manure on top of the grass clippings in step 86. A mixture of bone marrow and superphosphate and/or rock phosphate are then placed on top of the cow manure and dampened with water in step 88. A layer of soil is then placed on top of the bone marrow mixture in step 90 without filling the hole. Next, in step 92, the fertilizer delivery device provided in step 72 is placed on the top layer of soil in the bottom of the hole. The bottom of the container containing the plant that was allowed to grow in step 76 is then removed and the container containing the plant having the bottom removed is then placed within the opening of the fertilizer delivery device in step 94.

In step 96, the open area of the hole around the fertilizer delivery device is filled with soil without covering the fertilizer delivery device or the container. Next, in step 98, the area within the device contained around the opening which holds the container is filled with dried cow manure. A mixture of water and fish emulsion is then placed on top of the cow manure contained within the device in step 100. The bottom of the fertilizer delivery device which does not contain the container has a plurality of openings therethrough so that water and/or liquid can seep through the bottom of the fertilizer delivery device that is positioned around the container. Next, in step 102, the areas of the fertilizer delivery device having the openings in its bottom is filled with water so that it will seep out the bottom of the fertilizer delivery device giving the plant contained in the container the needed nitrogen for continuing growth in the form of a “manure tea”. Water should be poured into the fertilizer delivery device approximately once a week. Finally, in step 104, one may optionally stake and/or cage the plant contained in the container which sits inside the fertilizer delivery device.

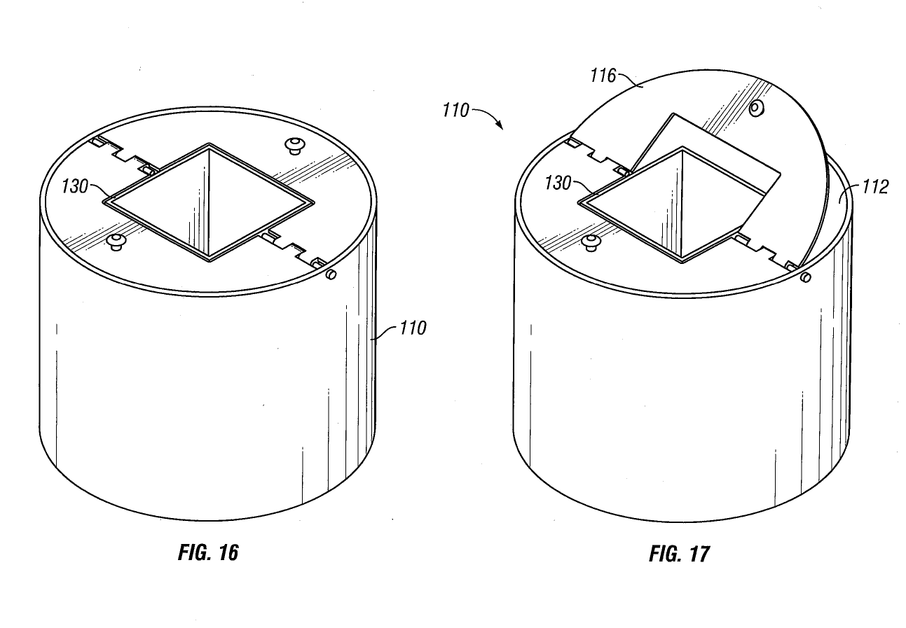

FIG. 16 is a perspective view of an exemplary embodiment of the fertilizer delivery device 110 of the present invention shown with a container 130 inserted into the fertilizer delivery device 110. FIG. 17 is a perspective view of the exemplary embodiment of the fertilizer delivery device 110 shown in FIG. 16 with a portion of the lid 116 shown open for accessing the interior of the fertilizer chamber 112 of the fertilizer delivery device 110. As described above in step 102, water is poured within the interior of fertilizer chamber 112 approximately once a week so that water can seep through the bottom of the fertilizer chamber 112 giving the plant the needed nitrogen for continuing growth in the form of a “manure tea”.

The present invention has been described above with reference to various exemplary embodiments. However, those skilled in the art will recognize that changes and modifications may be made to the exemplary embodiments without departing from the scope of the present invention. For example, the very steps, as well as the components for carrying out the steps, may be implemented in alternate ways depending upon a particular application. These and other changes or modifications are intended to be included within the scope of the present invention, as set forth in the following claims.

1. A fertilizer delivery device comprising:
a fertilizer chamber having an open top end and a closed bottom end, said bottom end having a plurality of openings contained therethrough; and
a hollow compartment having an open top end and an open bottom end wherein the hollow compartment is contained within, and completely surrounded by, the fertilizer chamber.

2. The fertilizer device of claim 1 wherein the fertilizer chamber and the hollow compartment are comprised of one continuous piece.

3. The fertilizer delivery device of claim 1 further comprising a lid member which fits over the open top end of the fertilizer chamber.

4. The fertilizer delivery device of claim 3 wherein the lid member comprises two pieces that are hingedly connected to one another.

5. A fertilizer delivery device comprising:
an outer hollow body member having an inner perimeter, an outer perimeter, a top end, and a bottom end;
an inner hollow body member having an inner perimeter, an outer perimeter, a top end, and a bottom end wherein said inner hollow body member is positioned within the outer hollow body member; and
a floor member having a plurality of small openings contained therethrough, said floor member being positioned between, and connected to, the inner perimeter of the bottom end of the outer hollow body member and the outer perimeter of the bottom end of the inner hollow body member thereby creating a fertilizer chamber contained between the inner perimeter of the outer hollow body member and the outer perimeter of the inner hollow body member.

6. The fertilizer delivery device of claim 5 wherein the outer hollow body member, the inner hollow body member, and the floor member all comprise one continuous piece.

7. The fertilizer delivery device of claim 5 wherein the outer hollow body member is cylindrical in shape.

8. The fertilizer delivery device of claim 5 wherein the inner hollow body member comprises at least one of a rectangular shape or a cylindrical shape.

9. The fertilizer delivery device of claim 5 further comprising a lid member connected to the top end of the outer hollow body member and the top end of the inner hollow body member such that the lid member covers the fertilizer chamber.

10. The fertilizer delivery device of claim 9 wherein the lid member comprises first and second pieces that are connected to one another by a hinge mechanism.

11. The fertilizer delivery device of claim 10 wherein the hinge mechanism comprises two hinge pieces wherein each hinge piece is connected to the first lid piece, the second lid piece, the outer perimeter of the inner hollow body member near the top end of the inner hollow body member, and the inner perimeter of the outer hollow body member near the top end of the outer hollow body member.

12. The fertilizer delivery device of claim 10 wherein the first and second pieces of the lid member are equal to one another in size and shape.

13. The fertilizer delivery device of claim 10 further comprising a knob member connected to the first piece of the lid member such that the first piece of the lid member can be easily raised to provide access to the fertilizer chamber.

14. The fertilizer delivery device of claim 13 further comprising a knob member connected to the second piece of the lid member such that the second piece of the lid member can be easily raised to access the fertilizer chamber.

15. A fertilizer delivery kit comprising:
a fertilizer delivery device having a fertilizer chamber completely surrounding a hollow compartment having an open top end and an open bottom end wherein the fertilizer chamber includes a bottom having a plurality of openings therethrough; and
at least one container capable of fitting within the hollow compartment wherein the container has an open top end and a closed bottom end.

16. The fertilizer delivery kit of claim 15 wherein the bottom end of the container includes perforations for easily removing all or a portion of the bottom end of the container.

17. The fertilizer delivery kit of claim 15 wherein the container is biodegradable.

18. The fertilizer delivery kit of claim 15 further comprising a plurality of containers.

19. The fertilizer delivery kit of claim 15 wherein the fertilizer chamber has an open top end.

20. The fertilizer delivery kit of claim 19 further comprising a lid member which fits over the open top end of the fertilizer chamber.

21. The fertilizer delivery kit of claim 15 further comprising a package of dried manure.

22. The fertilizer delivery kit of claim 15 further comprising a package of fish emulsion.
